(19) United States
(12) Patent Application Publication
(10) Pub. No.: US 2006/0096908 A1
(43) Pub. Date: May 11, 2006

(54) Device for filtering fluids that are conveyed under a high presure

(76) Inventors: Wilhelm Paul Wolf, Munster (DE); Jan G. Sprakel, Wermelskirchen (DE)

Correspondence Address: PROSKAUER ROSE LLP;PATENT DEPARTMENT, 1585 BROADWAY, NEW YORK, NY, 10036-8299, US

(21) Appl. No.: 10/516,667

(22) PCT Filed: May 14, 2003
(86) PCT No.: PCT/EP03/05032

§ 371 Date: Aug. 16, 2005

(30) Foreign Application Priority Data
Jun. 4, 2002 (DE) 102 24 634.3

(51) Int. Cl. B01D 35/28

(52) U.S. Cl. 210/450; 210/451; 210/455

(57) ABSTRACT

The device of the invention for filtering fluids conveyed at high pressure is easy to service and withstands very high pressures whilst having an appreciably larger filter area than conventional high-pressure filters. For this purpose it is provided with an inlet opening (21), an outlet opening (24) and a metal housing (2) that encloses a filter chamber (23) and has a service opening (3,4) which is closed by a lid (14,15), likewise of metal, which is seated by a contact force on a rim portion (5,6) surrounding the service opening (3,4) in direct contact with the metal of the housing (2), wherein the rim surface (7,8) of the rim portion (5,6) that is associated with the lid (14,15) slopes between its inner boundary edge (10) associated with the service opening (3,4) and its outer boundary edge (12) such that the rim surface (7,8) forms an angle (13) deviating from 90° with the adjacent inside surface (9) and outside surface (11) of the rim portion (5,6) and the contact surface between the lid (14, 15) and the rim portion (5,6) is limited to a fraction of the rim surface (7,8), and wherein there is arranged inside the filter chamber (23) a filter element (26) through which a fluid flows on its way from the inlet opening (21) to the outlet opening (24).

The invention relates to a device for filtering fluids that are conveyed at high pressure. Such filtering devices are required for example in the process industries, such as for example plastics production or biotechnology, to clean liquids that are handled during production. In these applications, the filter chamber must consistently remain tightly sealed from the environment at all times during operation.

Conventionally constructed filtering devices used in practice for high-pressure applications up to 4300 bar, for example of the type available from Hochdrucktechnik HOTEC GmbH, generally have a tubular housing which is coaxially integrated in high-pressure piping. These filters are fitted with a membrane filter element which, because it has a small filter surface, is capable of holding only small amounts of contaminants. In addition, the filter element causes extremely high pressure losses in large high-pressure fluid streams. Filters that are capable of holding large amounts of contaminants with little pressure loss are usually available only for moderate pressures up to a maximum of 500 bar.

In the known filtering devices, sufficient pressure resistance is available in the high-pressure versions only for a too small filter surface area. In contrast, in devices for moderate pressures up to 500 bar, a sufficiently large filter area is available only with an insufficient pressure resistance. Another disadvantage of the known devices for high-pressure use is that they have to be completely disconnected from the pipe connections for servicing.

Consequently, the aim of the invention was to provide an easily-serviced device which can, on the one hand withstand the very high pressures and which, on the other hand, has an appreciably larger filter area than conventional high-pressure filters.

This aim is achieved by a device for filtering fluids conveyed at high pressure which is provided with an inlet opening, an outlet opening, and a metal housing enclosing a filter chamber and having a service opening closed by means of a lid, also of metal, which is seated, by the action of a contact force, on a rim portion surrounding the service opening in direct contact with the metal of the housing, the rim surface of the rim portion associated with the lid sloping between its inner boundary edge associated with the opening and its outer boundary edge such that the rim surface forms an angle deviating from 90° with the adjacent inside surface and outside surface of the rim portion, and the contact surface between the lid and the rim is limited to a fraction of the rim surface, and wherein there is arranged inside the filter chamber a filter element through which fluid flows on its way from the inlet opening to the outlet opening.

A device in accordance with the invention has a housing that is provided with a service opening. This service opening is so arranged that the filter chamber enclosed by the housing is accessible through it. To ensure that the housing is fluid-tight even at high pressures, the rim surface on which the lid is seated slopes in such a manner that when the lid is placed thereon, the contact obtained between the lid and the rim is substantially linear. When the lid is then pressed onto the rim, a high concentration of force is obtained in the zone of contact. As a result, metal deformations occur in the contact zone, which results in a perfect fit between the shape of the rim surface and the shape of the lid surface that is in contact with it. This creates a metallic seal which reliably prevents fluid from escaping from the filter housing over a long period of operation, even at high pressure.

One particular advantage of the seal for the service opening in accordance with the invention is that there are no open gaps in which contaminants can become lodged. Thus, the device of the invention also satisfies the most stringent of hygiene standards, without the need for costly constructional measures.

Preferably, the filter element is a filter body which is seated on one of the walls that define the filter chamber and through which the fluid can flow in the region of at least one of its peripheral surfaces. The filter surface through which the fluid flows and hence the throughput through the filter can thus be increased. It is particularly advantageous for the sealing surface of filter element to surround-the outlet opening. In this arrangement, the filter body can freely project into the filter chamber from the wall in which the outlet opening is formed. This makes available a maximum filter surface area through which the fluid can flow. Additionally, the filter body can be cylindrical in shape, as is known per se for conventional filter cartridges.

Fitting the filter body can be made easier by the filter element being biased by a resilient force acting on the sealing surface from the filter chamber. The resilient force, powered for example by a spring, serves to hold the filter element until its sealing surface is automatically pressed against the associated wall of the housing by the pressurised fluid.

Another advantageous embodiment of the invention is characterised in that the housing is tubular. This variant of the invention not only results in an especially simple arrangement of a device in accordance with the invention, but it can be just as simply arranged to have two service openings. Each of the service openings is closed by means of a lid lying in direct contact with the metal of the housing and pressed onto a rim portion, and the rim surface of the rim portions that is associated with each of the lids slopes between its inner boundary edge associated with the opening and its outer boundary edge such that each rim surface forms an angle deviating from 90° with the adjacent inside surface and outside surface of the rim portion. The contact force that is required to tightly seat the lid can be generated by mutually tensioning the lids. For this purpose, there can be used tension screws or bolts that function like expansion screws and are able, by virtue of their extensibility, reliably to absorb sudden peak loads. The use of such extensible tension screws or bolts ensures that the device of the invention remains dependably and durably sealed over a long period of operation, even under adverse conditions.

The construction of a device in accordance with the invention can be further simplified by forming the inlet opening in one of the lids and the outlet opening in the other lid.

The invention will now be described in greater detail by reference to a drawing which illustrates an example thereof and in which

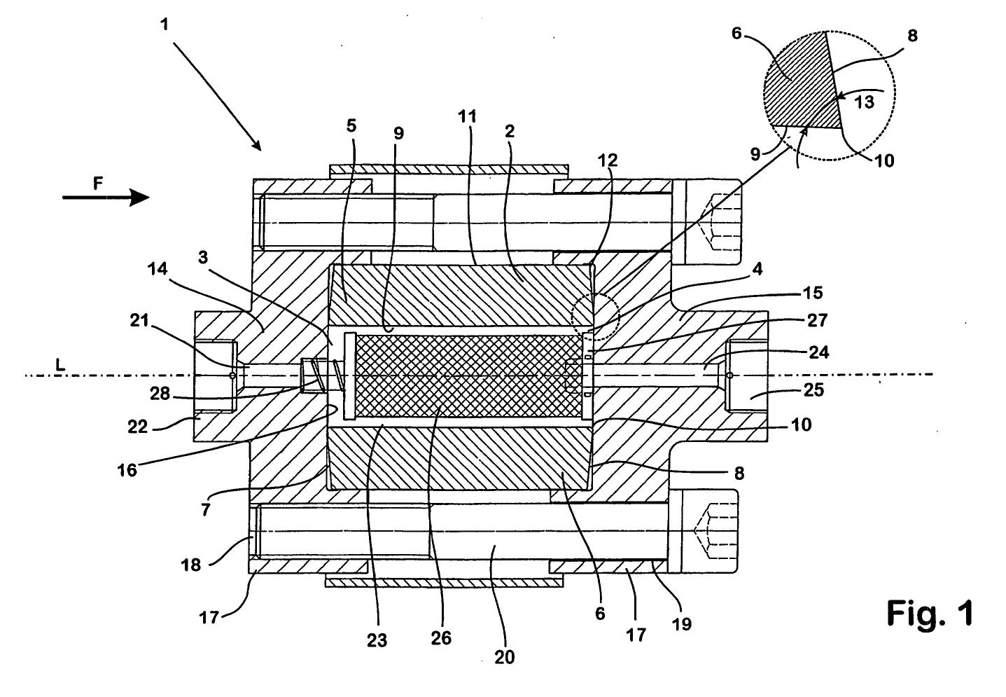

FIG. 1 is a longitudinal section through a device for filtering liquids used in process industry production;

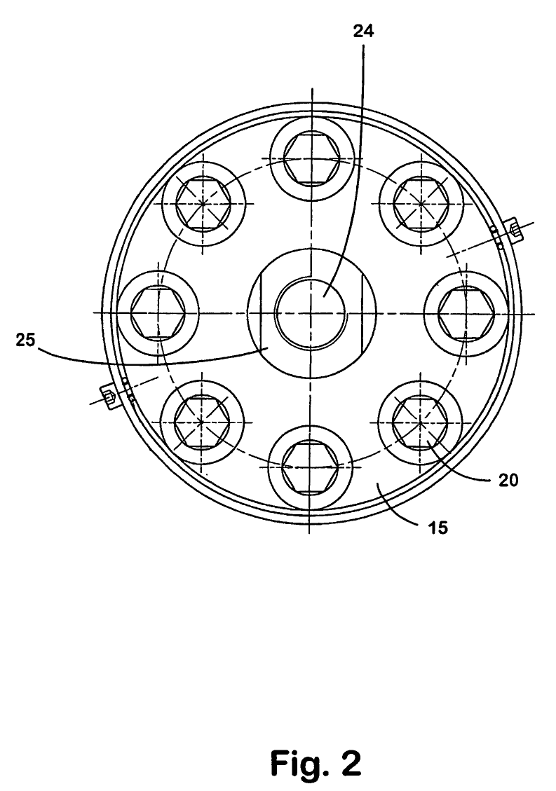

FIG. 2 is an end view of the device shown in FIG. 1;

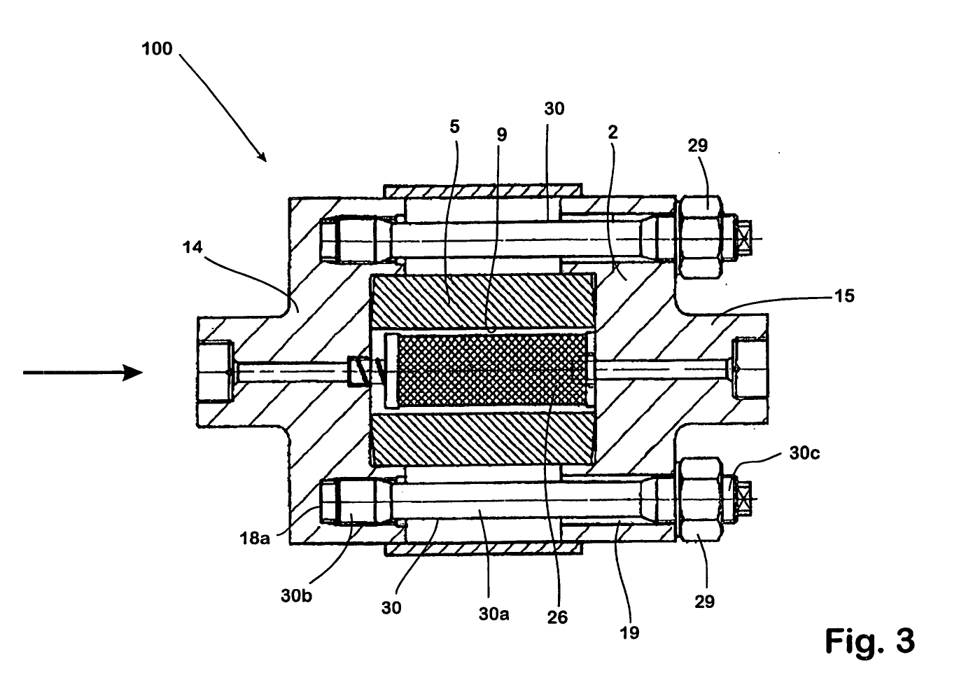

FIG. 3 is an alternative embodiment of the device shown in FIG. 1.

The device 1 comprises a tubular housing 2 built from a suitable material such as for example steel or a different metal, a composite material, or a ceramic, having a service opening 3,4 at each of its ends. The diameter of the service openings 3,4 corresponds to the pipe diameter of the housing 2. The rim portion 5,6 of the housing 2 that surrounds each of the service openings 3,4 has a rim surface 7,8 formed on the end faces of the housing 2. This rim surface 7,8 slopes away from its rim edge 10 which is associated with the inside surface 9 of the housing 2, in the direction of its outside rim edge 12 associated with the outside surface 11 of the housing 2 such as to include an acute angle 13 between the rim surfaces 7,8 and the inside surface 9 of the housing 2.

A lid 14,15 is placed on the rim surfaces 7,8. The lid surface 16 associated with the rim surfaces 7,8 is flat such that in the region of the inside rim edge 10 of the rim surfaces 7,8 a substantially linear contact is obtained between the lid surface 16 and the rim surfaces 7,8. The lateral rim portion 17 of the lids 14,15 encompasses the outside surface 11 of the housing 2 in the region of the rim portions 5,6 such that the lids are centred on the end faces of the housing 2.

In the lid 14 which is the first to be passed in the direction of flow F, there are formed at regular angular distances about the longitudinal axis L of the device 1 threaded bores 18 whose axes are parallel to the longitudinal axis L. In the opposite lid 15 there are provided in the same layout through-bores 19 aligned with the threaded bores 18. Tension screws 20 are passed through the through-bores 19 with their heads abutting the external side of the lid 15 averted from the lid 14, and their threaded portions screwed into the associated threaded bores 18.

In this manner, the lids 14, 15 can be mutually tensioned such as to exert a high contact force against rim surfaces 7,8. Because the contact surface between the lids 14,15 and the rim surfaces 7,8 is substantially limited to a line, forces are highly concentrated in this contact zone. As a consequence, the metal of the rim portions 5,6 and the lids 14,15 is deformed in the contact zone so as to create a durably tight metallic seal between the housing 2 and the lids 14, 15 that can dependably withstand high pressures of up to 1500 bar.

In the lid 14 which is the first to be passed in the direction of flow F there is formed an inlet opening 21 extending coaxially to the longitudinal axis L which leads from a connecting piece 22 formed on the external surface of the lid 14 into the cylindrical filter chamber 23 surrounded by the housing 2. In the opposite lid 15 there is formed in alignment with the inlet opening 21 and likewise coaxially to the longitudinal axis L, an outlet opening 24 which leads from the filter chamber 23 to a connecting piece 25 formed on the external surface of the lid 15.

Within the cylindrical filter chamber 23 there is arranged a likewise cylindrical filter body 26 whose diameter is smaller than the diameter of the filter chamber 23. At its end sealing surface 27 associated with the lid 15, the filter body 25 lies sealingly against the lid surface 16 of the lid 15 and surrounds the outlet opening 24 such that the outlet opening of the filter body 23 which is not shown passes directly into the outlet opening 24 of the device 1. The axial extension of the filter body 26 is so dimensioned that its end wall associated with the lid 14 lies at a distance from the lid surface of the lid 14. A spring 28 seated in a recess of the lid 14 exerts a resilient force on the filter body 26, the said force urging the filter body 26 and its sealing surface 27 against the lid surface 16 of the lid 15. The peripheral surface of the filter body 26 is formed as a filter membrane.

In the final assembled condition, pipes (not shown here) are screwed into the connecting pieces 22, 25. When the fluid to be filtered flows into the filter chamber 23, the filter body 26 with its sealing surface 27 is urged by the fluid against the lid surface 16 of the lid 15. The fluid flows around the filter body 26 and passes through the filter membrane provided on its peripheral surface before flowing out from the device 1 through the outlet opening 24.

When the filter body 26 needs to be serviced, the tension screws 20 are unscrewed. The device 1 can then be easily separated into its individual components, serviced, and then reassembled in the same way.

The device 100 shown in FIG. 3 differs from the device 1 only in that instead of the tension screws 20 used in device 1, there are used in the device 100 tension bolts 30 that have a shank portion 30a with a smaller cross-section than the other parts of the tension bolt 30 in order to improve their extension behaviour. At their ends, the tension bolts 30 have a threaded portion 30b, 30c.

The threaded portion 30b associated with the lid 14 is screwed into a threaded bore 18a formed as a blind hole in the lid 14, while the other threaded portion is passed through the through-bore 19 of the other lid 15 and projects at least partly from the side of the lid 15 averted from the lid 14. Onto this projecting section of the threaded portion 30c there is screwed a nut 29 which mutually tensions the lids 14 and 15. The advantage of using tension bolts 30 that act as expansion bolts is that the tensioning thereby obtained can react in a more elastic manner to peak loads so that as a result greater pressing forces can be applied which provide a greater security of the seal.

### REFERENCE NUMERALS

1 Device

2 Housing

3,4 Service openings

5,6 Rim portions

7,8 Rim surfaces

9 Inside surface of the housing 2

10 Inner rim edge of rim surfaces 7,8

11 Outside surface of housing 2

12 Outer rim edge of rim surfaces 7,8

13 Angle between the inside surface and the rim surface

14,15 Lids

16 Lid surface

17 Rim portion

18,18a Threaded bores

19 Through-bores

20 Tension screws

21 Inlet opening

22 Connecting piece

23 Filter chamber

24 Outlet opening

25 Connecting piece

26 Filter body

27 Sealing surface

28 Spring

29 Nuts

30 Tension bolts

30a Shank portion of tension bolts 30

30b, 30c Threaded portions of tension bolts 30

F Direction of flow

L Longitudinal axis of device 1

1. A device for filtering fluids conveyed at high pressure with an inlet opening an outlet opening and a metal housing enclosing a filter chamber and having a service opening closed by means of a lid also of metal, which is seated by the action of a contact force on a rim portion surrounding the service opening in direct contact with the metal of the housing the rim surface of the rim portion associated with the lid sloping between its inner boundary edge that is associated with the service opening and its outer boundary edge such that the rim surface forms an angle deviating from 90° with the adjacent inside surface and outside surface of the rim portion and the contact surface between the lid and the rim portion is limited to a fraction of the rim surface and wherein there is arranged inside the filter chamber a filter element through which fluid flows on its way from the inlet opening to the outlet opening.

2. A device according to claim 1,
wherein
the filter element is a filter body which is seated on one of the walls that define the filter chamber and through which the fluid can flow in the region of at least one of its peripheral surfaces.

3. A device according to claim 2,
wherein
the sealing surface of the filter element surrounds the outlet opening

4. A device according to claim 2,
wherein
the filter element is biased by resilient force acting from the filter chamber on the sealing surface.

5. A device according to claim 2
wherein
the filter element is cylindrical in shape.

6. A device according to claim 5
wherein
the service openings are formed on the end faces of the tubular housing.

7. A device according to claim 1
wherein
the housing is is tubular.

8. A device according to claim 1
wherein
the lids are mutually tensioned.

9. A device according to claim 8
wherein
the tensioning is obtained by tension screws or tension bolts that act like expansion screws.

10. A device according to claim 8
wherein
the inlet opening is formed in one of the lids and the outlet opening is formed in the other of the lids.
